(19) United States
(12) Patent Application Publication
(10) Pub. No.: US 2011/0064255 A1
(43) Pub. Date: Mar. 17, 2011

(54) AUDIO EQUIPMENT

(76) Inventor: Marcus Lewis, Herefordshire (GB)

(21) Appl. No.: 12/669,154

(22) PCT Filed: Jul. 17, 2008
(86) PCT No.: PCT/GB2008/002421

§ 371 Date: Dec. 1, 2010

(30) Foreign Application Priority Data
Jul. 17, 2007 (GB) 0714081.7
Aug. 21, 2007 (GB) 0716270.4

(51) Int. Cl. H04R 1/02

(52) U.S. Cl. 381/381

(57) ABSTRACT

Audio equipment comprising a frame having a face and a pair of temples hingedly connected thereto, a conductor extending across the face to electrically connect audio modules associated with the temples, the face including grooves adapted to receive parts of lenses and a channel extending across a bridge region and interconnecting the grooves, the conductor extending through at least parts of the grooves and the channel.

This invention relates to audio equipment, and in particular to audio equipment designed to be worn on the head.

Designs of audio equipment are known in which a spectacles or sunglasses frame is provided with or carries, for example, a radio receiver and speakers or headphones to allow a user to listen to the radio. Other similar devices incorporating, for example, MP3 or other data file players, or mobile telephone devices are also known.

Where the audio equipment includes two speakers, and so requires signals to be transmitted from one temple of the spectacles or sunglasses to the other, or where the equipment includes circuit components located in or associated with both temples, electrical connections must be provided between the temples. This may be achieved using cables passing behind or around the user's head or neck, or may be achieved by passing cables across the face of the spectacles or sunglasses. Passing cables across the face of the spectacles or sunglasses restricts the range of possible designs of spectacles or sunglasses and this is undesired. Further, where circuit components are associated with the temples, cables must pass between the face and the temples and must be capable of bending or flexing to accommodate movement of the temples between their open and closed positions.

According to one aspect of the invention there is provided audio equipment comprising a frame having a face and a pair of temples hingedly connected to the face, a conductor passing across the face and terminating at connectors provided on the face and located adjacent the temples, and audio modules attachable to the temples and having connector engageable with the connectors provided on the face.

Such an arrangement is advantageous in that the temples do not include circuits or electrical components, and further that no cables have to pass through the hinges.

The audio modules may serve a number of functions. For example they may act as radio receivers, MP3 or data file players, mobile telecommunications devices, hands free devices for use with mobile telecommunications devices, telephone messaging services, or combinations thereof. They conveniently further carry speakers to be positioned in or adjacent the user's ears.

Conveniently, the face includes grooves adapted to receive parts of the lenses, of the spectacles or sunglasses and a channel extending across a bridge region of the face and interconnecting the grooves, the conductor extending through at least parts of the grooves and the channel. The conductor conveniently incorporates an elastomeric sheath arranged to be engaged, in use, by the lenses to support and/or apply a biasing load thereto.

The invention also relates to audio equipment comprising a frame having a face and a pair of temples hingedly connected thereto, a conductor extending across the face to electrically connect audio modules associated with the temples, the face including grooves adapted to receive parts of lenses and a channel extending across a bridge region and interconnecting the grooves, the conductor extending through at least parts of the grooves and the channel. The conductor may include an elastomeric sheath adapted to support and/or apply a biasing load to the lenses.

It will be appreciated that such location of the conductor reduces the limitations on the range of face designs, and that the provision of an elastomeric sheath avoids the need to place other biasing means into the grooves to support the lenses.

The invention also relates to a spectacles frame comprising a face and a pair of temples hingedly mounted upon the face, the face having associated therewith a releasable retainer mechanism whereby lenses are mounted to the face, wherein each lens has a dummy frame part associated therewith. The dummy frame parts may be adhered to the lenses.

The releasable retainer mechanism conveniently comprises a retainer pivotally mounted to the face and movable between a retaining position and a released position.

The provision of releasable lenses with dummy frame parts allows lens replacement to be undertaken without having to touch the lens surfaces thus reducing the risk of damaging any coatings applied thereto.

The invention will further be described, by way of example, with reference to the accompanying drawings, in which:

FIG. 1 is a perspective view illustrating audio equipment in accordance with one embodiment of the invention.

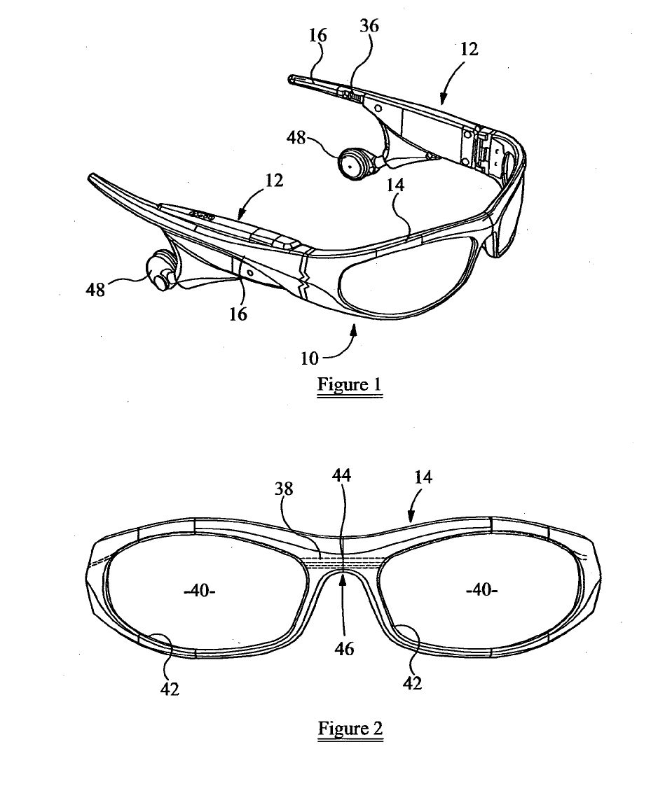

FIG. 2 is a view of the face part of the audio equipment;

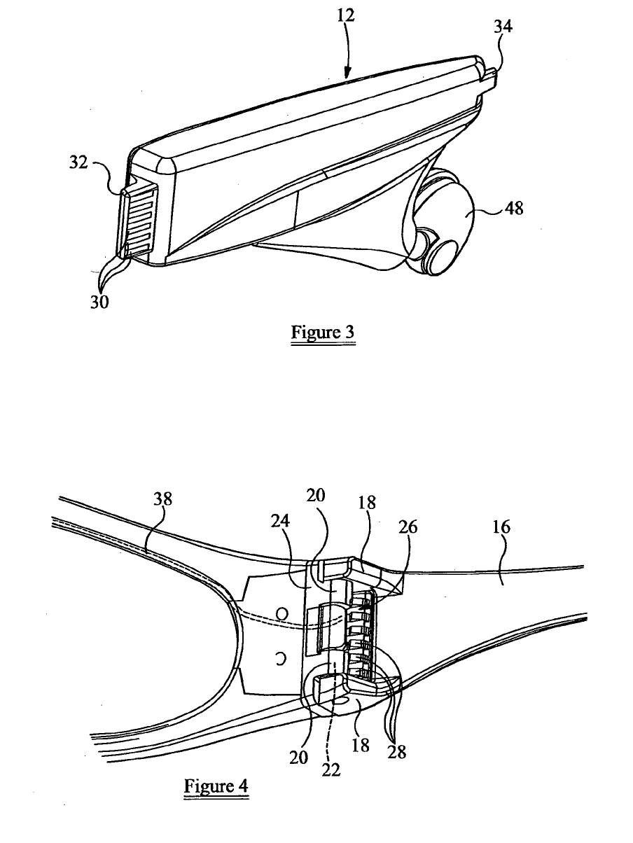

FIG. 3 is a view of one of the audio modules;

FIG. 4 illustrates part of the face and one of the temples with the audio module omitted, with the temple in an open position;

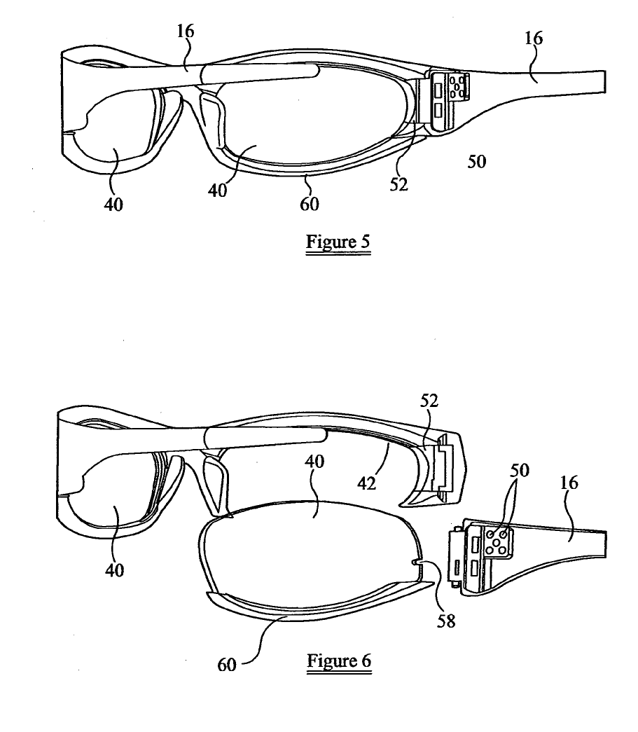

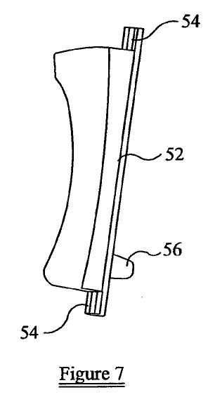

FIGS. 5 to 7 illustrate another embodiment;

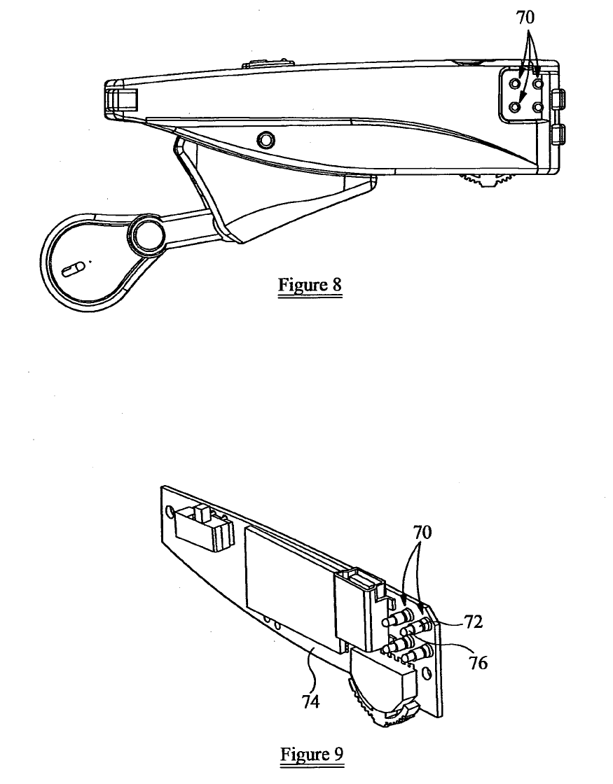

FIGS. 8 and 9 illustrate an audio module; and

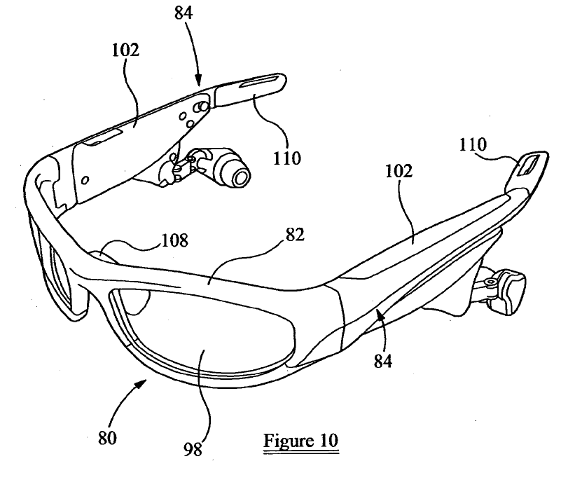

FIGS. 10 to 22 illustrate another embodiment.

The audio equipment illustrated in FIGS. 1 to 4 of the accompanying drawings comprises a spectacles or sunglasses frame 10 designed to have removably mounted thereon a pair of audio modules 12. The frame 10 comprises a face 14 to which is hingedly mounted a pair of temples 16. The hinged connection is best illustrated in FIG. 4 and comprises a pair of hinge formations 18 provided on the temple 16 arranged to co-operate with corresponding hinge formations 20 provided on the face 14, the hinge formations 18, 20 each defining an opening, the openings being aligned with one another, pivot pins 22 extending through the aligned openings.

The hinge components 20 form part of a connector unit 24 which is secured to the remainder of the face 14. The connector unit 24 defines a recess 26, an inwardly facing wall of which is provided with a series of terminals 28 for electrical connection to corresponding terminals 30 formed on a projection 32 provided at a front end of each audio module 12.

In use, with the frame 10 arranged such that the temples 16 thereof are in their open condition, the modules 12 can be secured to the frame 10 by introducing the projection 32 of each module 12 into the corresponding recess or socket 26. Once this has been done, a further projection 34 provided at the opposite end of the module 12 can be snapped or otherwise fitted past a slide member 36 formed on the associated temple 16 into a corresponding recess to secure the module 12 in position. It will be appreciated that in this position, the connector terminals 28 provided in the connector unit 24 bear against the terminals 30 provided on the projection 32 thus providing an electrical connection between circuits contained within the audio module 12 and the spectacles frame 10. The terminals 28 provided in the connector unit 24 take the form of resilient, spring-like elements biased away from the wall on which they are mounted so as to ensure that good electrical contact is maintained with the terminals 30.

The terminals 28 provided adjacent one of the temples 16 are each electrically connected to one end of a series of conductor elements of a multi-cote cable or conductor 38, the other ends of which are connected to the terminals 28 provided adjacent the other of the temples 16. It will therefore be appreciated that, in use, an electrical connection is provided between the circuits provided in the audio modules 12.

The face 14 of the spectacles frame 10 is shaped to define a pair of openings in which lenses 40 are mounted, in use. The peripheral regions of the lenses 40 are received within corresponding grooves 42 provided in the face 14. As illustrated in FIG. 2, a channel 44 is provided in the face 14, the channel 44 extending across a bridge region 46 of the face 14 interconnecting the grooves 42 surrounding the two openings. The conductor 38 is located within and extends through parts of the grooves 42 and across the channel 44. It will be appreciated that such location of the conductor 38 does not introduce significant design restrictions on the design of the face 14. Further, the conductor 38 is conveniently provided within an elastomeric sheath against which edge regions of the lenses 40 abut, the sheath supporting and/or applying a biasing force to the lenses 40, assisting in securing the lenses 40 in position. It will be appreciated that in the absence of the electrical sheathed conductor 38, separate elastomeric material elements would most likely be required in the grooves 42.

It will be appreciated that, in accordance with one aspect of the invention, the audio modules 12 are directly electrically connected to the face 14 rather than being electrically connected to the temples 16. By electrically connecting the audio modules 12 directly to the face 14, the temples 16 need not be provided with electrical components or conductors and so can be of simpler design. Further, there is no need to pass an electrical connection through the hinge by which the temples 16 are connected to the face 14. Again, this results in a much simpler construction. As the temples 16 are electrically inert, if desired it may be possible to permit the temples to be interchanged.

It will be appreciated that the audio modules 12 may take a range of forms. For example, they may serve as an MP3 or other data file player arranged to output signals through speakers 48 located adjacent the wearer's ears, in use. Another possibility is for the modules 12 to form part of a mobile telecommunications apparatus or hands-free set for use therewith. They could also incorporate a telephone messaging service or a range of other features. Depending upon the function of the modules 12, appropriate circuits and buttons or switches for use in controlling the operations thereof will be provided.

FIGS. 5 to 7 illustrate an alternative arrangement which, in many respects is similar to that of FIGS. 1 to 4 and only the significant differences will be described. Firstly, the audio modules of this arrangement are arranged to make electrical connections with terminal pads 50 provided on the temples 16. The terminal pads 50 are connected to cables passing across the face 14 as described hereinbefore, the cables also passing through the hinges whereby the temples 16 are mounted to the face 14.

Hingedly mounted to the face 14 are lens retainers 52, the retainers 52 being hinged to the face 14 by integral hinge pins 54 which are received in corresponding recesses formed in the face 14. Each retainer 52 is movable between a first, in-use position in which a protrusion 56 thereon is receivable within a recess 58 provided in the periphery of the associated lens 40, and a second position in which the protrusion 56 is withdrawn from the recess 58.

The lens 40 and the associated retaining grooves 42 formed in the face 14 are designed such that, when the retainer 52 occupies its second position, the lens 40 can be introduced into or removed from the face 14. With the lens 40 located in the face 14, movement of the retainer 52 to its first position introduces the protrusion 56 into the recess 58, thereby preventing escape of the lens 40 from the face 14.

It is apparent from the drawings that the retainer 52 is designed such that, when in its first position, its contours blend with those of the remainder of the face 14, and hides the recess 58.

The face 14 does not cover the lower edges of the lenses 40, and these have dummy frame parts 60 secured thereto, for example by adhesive. The provision of the dummy frame parts 60 allows handling of the lenses 40 without actually contacting the lens surfaces, thus the risk of damage to any coatings applied thereto is reduced.

FIGS. 8 and 9 illustrate an audio module of the type suitable for use with the arrangement of FIGS. 5 to 7. As shown, the audio module includes a plurality of contact pins 70 arranged to bear, in use, against the contact terminal pads 50. The pins 70 each include an outer part 72 mounted upon a circuit board 74, and an inner part 76 movable, telescopically, relative to the outer part and resiliently biased towards an outer position. The resilient biasing of the inner parts 76 ensures that, in use, a good electrical contact is maintained between the module and the remainder of the audio apparatus.

FIGS. 10 to 22 illustrate another embodiment, and a few variants thereof, which, for the most part, are very similar to the arrangements described hereinbefore. The embodiment of FIGS. 10 to 22 comprises a glasses frame 80 comprising a face 82 to which a pair of temples 84 is hingedly mounted. The face 82, as described hereinbefore, comprises an upper part 86 and a lower part 88 secured to one another and defining a channel 90 extending across a nose region 92 through which a cable 94 passes, the cable 94 being fitted into lens retaining grooves 96 formed in the face 82 and being provided with an elastomeric sheath serving to cushion firmly locate the lenses 98 in the grooves 96, in use. The cable 94 passes through the hinges to the temples 84, where the ends of the conductors of the cable 94 are electrically connected to connection pads 100 such that circuits located within modules 102 mounted upon the temples 84 can be electrically connected to one another.

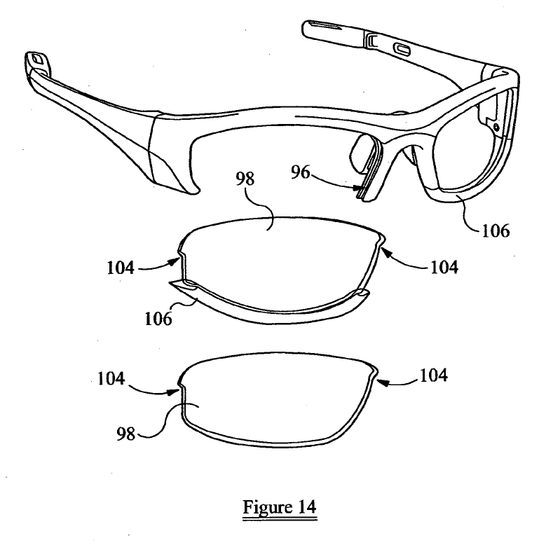

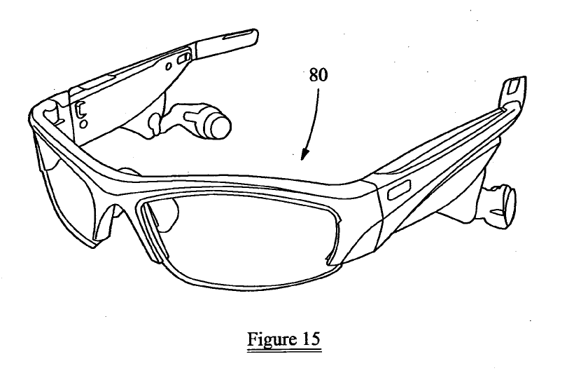

The lenses 98 are removably mounted to the face 82. As illustrated, each lens 98 includes a pair of recesses 104, the grooves 96 including corresponding locating formations. In use, to remove or insert a lens 98, the face 82 is deflected as permitted by the resilience of the material from which it is made to permit the passage of parts of the lens 98 into or out of the corresponding groove 96, release of the face 82 resulting in the face deflecting back to its original condition. When a lens 98 is inserted, it will be appreciated that such deflection results in the formations being located within the recesses 104, securing the lens 98 in position. As shown in FIG. 14, the lens 98 may have a lower face part 106 secured thereto so that, when secured to the remainder of the face 82, the face has a full frame appearance. Alternatively, the part 106 may be omitted with the result that the face 82 has a half frame appearance as shown in FIG. 15.

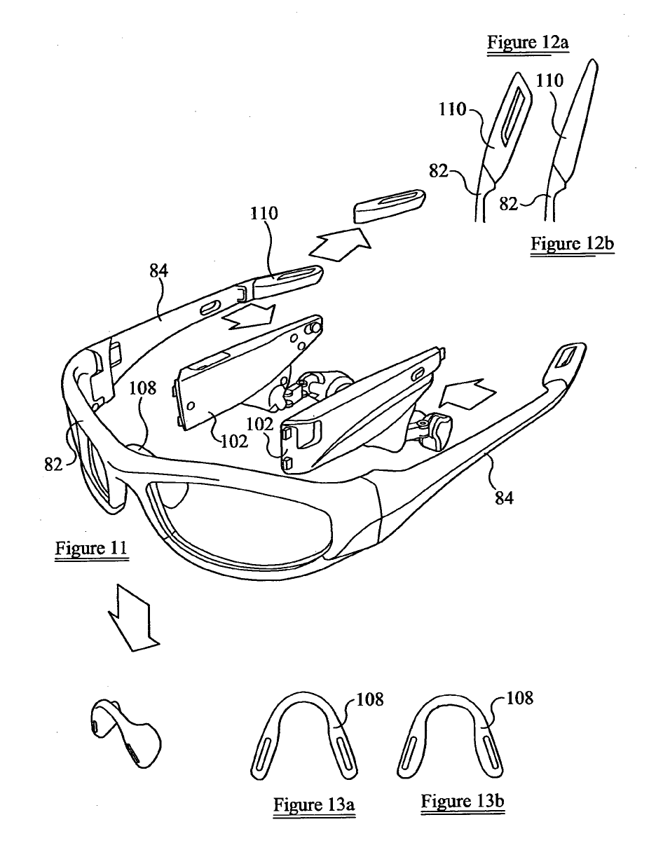

The nose region 92 of the face 82 is provided with a removable nose pad or cushion 108, to allow differently shaped or sized cushions 108 to be used as shown in FIGS. 13a and 13b. Interchanging of the cushions 108 may permit a better grip or fit to be attained, or may permit changes to be made to the appearance of the frame 80. Likewise, the ends of the temples 84 are provided with interchangeable grips 110, the profiles of which can be changed to achieve a desired fit or grip, or to alter the appearance of the frame 80. Some alternative grips 110 are shown in FIGS. 12a and 12b.

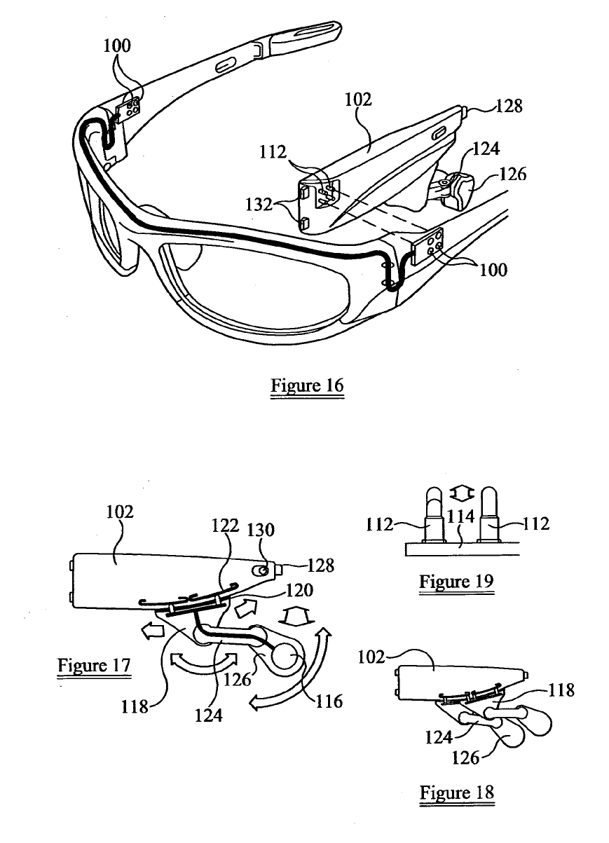

The modules 102 include spring loaded connecting pins 112 arranged to bear, in use, against the pads 110 to provide the electrical connections to the cable 94. The spring loaded pins 112 are illustrated in FIG. 19. As illustrated, they are mounted upon the circuit board 114 carrying the circuits of the module 102.

Each module 102 includes a speaker 116, as described hereinbefore. The speaker position is adjustable to permit comfortable use of the equipment by a range of users. As shown in FIG. 17, this is achieved in a number of ways. Firstly, the module 102 includes a lower part 118 slidably mounted to the remainder thereof. A sliding electrical contact is achieved between the module parts using pins 120 carried by the lower part 118 which bear against contact strips 122, for example of chrome plated form, carried by the module 102. Pivotally connected to the lower part 118 is a lower part 118 which bear against contact strips 122, for example of chrome plated form, carried by the module 102. Pivotally connected to the lower part 118 is a connecting arm 124 to which the housing 126 of the speaker 116 is pivotally mounted. It will be appreciated that the two axes of pivotal movement, in combination with the sliding movement of the lower part 118, permits a very wide range of speaker positions to be attained, as shown in FIGS. 17 and 18. At least one of the pivotal connections is preferably designed to permit lateral movement of the speaker 116.

The modules 102 are releasably mounted to the temples 84, and this is achieved by means of a reliantly biased slidable latch 128, an actuator 130 being provided to permit movement of the latch 128. To secure the modules 102 in position, fixed locating pins 132 are located within corresponding recesses formed in the temples 84, and the modules 102 pushed home, resulting in deflection of the latch 128 to allow it to be received within a corresponding recess. Release of the modules 102 is achieved by using the actuator 130 to move the latch 128 out of its recess; whereon the module 102 can be removed.

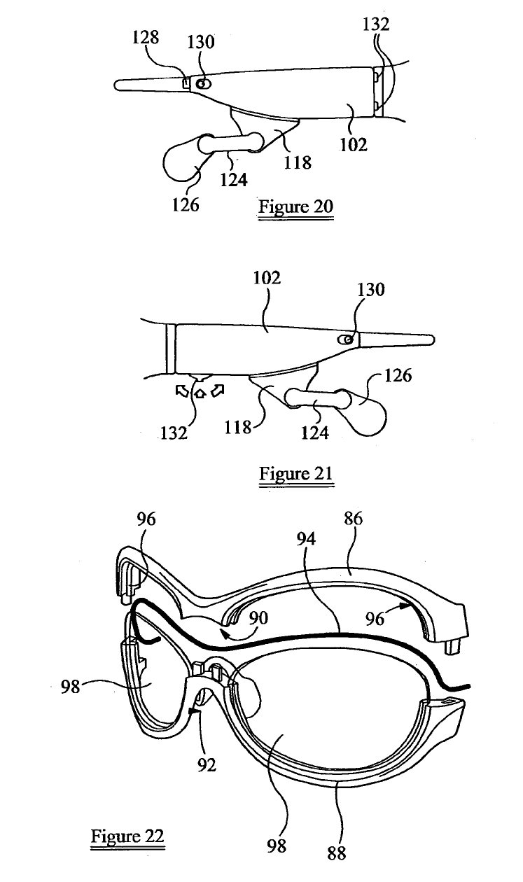

As described hereinbefore, the modules 102 may perform a range of functions. For example, they may serve as MP3 file players, stereo Bluetooth devices, mobile telephone answering/messaging devices, radio devices, or camera devices. It will be appreciated that this list is not exhaustive. In each case, it is envisaged that the module located on one temple will serve as a power supply whilst the other will include circuits to achieve the desired functions. However, the invention is not restricted to such arrangements. To minimise the number of control actuators required to control operation of the modules 102, a multifunction joggle wheel 132 is provided as shown is FIG. 21.

It will be appreciated that operation of the equipment of FIGS. 10 to 22 is substantially as described hereinbefore and so no separate detailed description of the operation thereof is included herein.

It will be appreciated that a range of modifications and alterations to the audio equipment may be made without departing from the scope of the invention.

1. Audio equipment comprising a frame having a face and a pair of temples hingedly connected thereto, a conductor extending across the face to electrically connect audio modules associated with the temples, the face including grooves adapted to receive parts of lenses and a channel extending across a bridge region and interconnecting the grooves, the conductor extending through at least parts of the grooves and the channel.

2. Equipment according to claim 1, wherein the conductor includes an elastomeric sheath adapted to support and/or apply a biasing load to the lenses.

3. A spectacles frame including a face and a pair of temples hingedly mounted upon the face, the face having associated therewith a releasable retainer mechanism whereby lenses are mounted to the face, wherein each lens has a dummy frame part associated therewith.

4. A frame according to claim 3, wherein the dummy frame parts are adhered to the lenses.

5. Audio equipment comprising a spectacles frame and a pair of audio modules securable to the frame, each module including a speaker, wherein the speaker is carried by a lower part slidably mounted to the associated module.

6. Equipment according to claim 5, wherein the speaker is pivotally connected to a connecting arm.

7. Equipment according to claim 6, wherein the connecting arm is pivotally connected to the lower part.

8. Equipment according to claim 5, wherein a sliding electrical connection is provided between the module and the lower part.
